(19) United States
(12) Patent Application Publication
(10) Pub. No.: US 2015/0378283 A1
(43) Pub. Date: Dec. 31, 2015

(54) IMAGE FORMING APPARATUS

(71) Applicants: KABUSHIKI KAISHA TOSHIBA, Minato Tokyo (JP); TOSHIBA TEC KABUSHIKI KAISHA, Shinagawa Tokyo (JP)

(72) Inventor: KOJI TAKAHASHI, Sumida Tokyo (JP)

(21) Appl. No.: 14/318,317

(22) Filed: Jun. 27, 2014

(51) Int. Cl. G03G 15/16

(52) U.S. Cl. CPC G03G 15/1665

(57) ABSTRACT

According to one embodiment, an image forming apparatus includes a power supply unit that outputs a transfer bias voltage, and a transfer unit that electrostatically transfers a toner image onto a sheet using a transfer bias voltage applied by the power supply unit, and has a transfer resistance value larger than 4.0×10⁷ Ω.

### FIELD

Embodiments described herein relate generally to an image forming apparatus.

### BACKGROUND

Recycling of a sheet on which decolorable toner is used is performed. The decolorable toner is toner of which a color is erased due to an external stimulus such as heat or light. As used herein, “erased” means to render the image not readily detectable to the human eye when on the printed sheet.

The toner of which the color is erased remains attached to the sheet as is. For this reason, when recycling of the sheet is repeated, toner accumulates on the sheet. A resistance value of the sheet is thus changed as the toner accumulates on the sheet. It is not easy to perform appropriate printing on sheets having resistance values which are different from each other.

### DESCRIPTION OF THE DRAWINGS

FIG. 1 is a block diagram of an image forming apparatus according to an embodiment.

FIG. 2 is a diagram illustrating a configuration of a printing unit.

FIG. 3 is an enlarged view of a transfer unit and a power supply unit of the image forming apparatus.

FIG. 4 is a diagram illustrating a relationship between a transfer current which flows on a sheet and transfer efficiency.

FIG. 5 is a diagram illustrating a relationship between the number of recycling times of a sheet and a sheet resistance value.

FIG. 6 is a diagram illustrating a relationship between the number of recycling times of the sheet and a transfer bias voltage which is applied to a secondary transfer roller.

FIG. 7 is a diagram illustrating a relationship between a transfer resistance value of the secondary transfer roller and a transfer current which flows in a new sheet.

FIG. 8 is a diagram illustrating correction voltage information for having correspondence to a fluctuation of a transfer resistance value of the secondary transfer roller due to a change in environmental conditions.

FIG. 9 is a diagram illustrating correction voltage information for having correspondence to a fluctuation of a sheet resistance of a sheet S due to the change in environmental conditions.

FIG. 10 is a flowchart illustrating transfer processing in the embodiment.

FIG. 11 is a diagram illustrating a relationship between the transfer resistance value of the secondary transfer roller and a relative humidity.

FIG. 12 is a diagram illustrating a relationship between the sheet resistance value of the sheet and the relative humidity.

FIG. 13 is a diagram illustrating a configuration of a direct transfer-type printing unit.

FIG. 14 is a block diagram of an image forming apparatus including an image erasing unit.

### DETAILED DESCRIPTION

Embodiments provide an image forming apparatus including a power supply unit capable to output a voltage equal to or greater than a lower limit transfer bias voltage at which a lower limit transfer current in a range of an appropriate transfer current which is predetermined flows in a sheet of which recycling is limited, and a transfer unit that includes at least a bias roller which transfers a toner image onto a sheet by charging the image using a voltage applied by the power supply unit, and has a transfer resistance value which is larger than a lower limit transfer resistance value in which the transfer current which flows on the sheet becomes an upper limit in the range of the appropriate transfer current, when the sheet is a new sheet, and a voltage applied to the bias roller is the lower limit transfer bias voltage.

Hereinafter, the embodiment will be described with reference to drawings. In addition, in the figures, the same or equivalent elements will be given the same reference numerals.

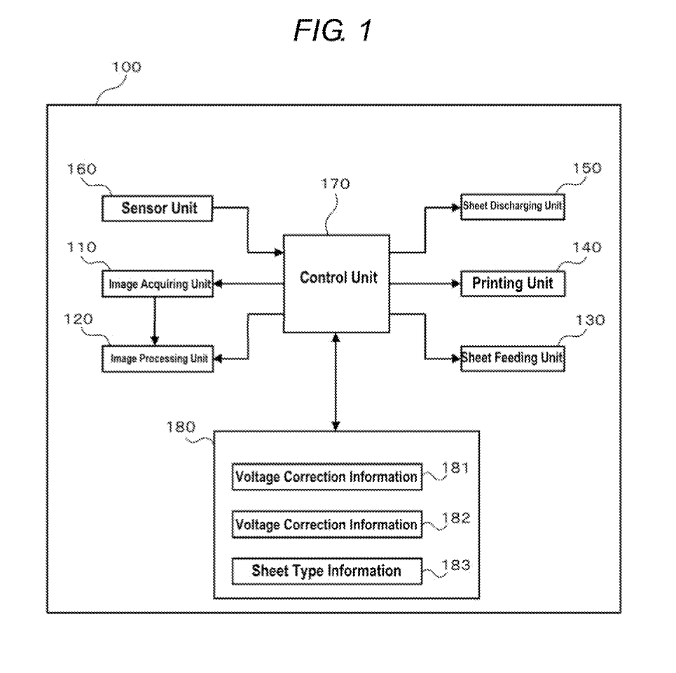

An image forming apparatus according to the embodiment is an image forming apparatus which has a printing function such as a copy machine, a printer, or a fax machine. As illustrated in FIG. 1, an image forming apparatus 100 includes an image acquiring unit 110, an image processing unit 120, a sheet feeding unit 130, a printing unit 140, a sheet discharging unit 150, a sensor unit 160, a control unit 170, and a storage unit 180.

The image acquiring unit 110 is a unit which acquires image data from outside of the image forming apparatus 100. The image acquiring unit 110 includes, for example, a scanner which reads an image from a paper medium. When acquiring image data from outside, the image acquiring unit 110 transmits the acquired image data to the image processing unit 120.

The image processing unit 120 includes a processing unit such as a processor. The image processing unit 120 converts the acquired image data from the image acquiring unit 110 into a data format which may be subject to a printing process in the printing unit 140.

The sheet feeding unit 130 is a unit which feeds a sheet S to the printing unit 140. The sheet feeding unit 130 includes, for example, a sheet feeding tray in which the sheet S is loaded, a pickup roller which takes the sheet S out from the sheet feeding tray, or the like. The sheet S which is fed from the sheet feeding unit 130 passes through a transfer unit 148 which will be described later at a speed of 100 mm/s to 200 mm/s, or preferably at a speed of 150 mm/s. In addition, the sheet S which is fed from the sheet feeding unit 130 may be a non-used sheet which was not subject to a decoloring process even once, (hereinafter, referred to as “new sheet”), or may be a sheet of which an image is erased using the decoloring process (hereinafter, referred to as “recycled sheet”).

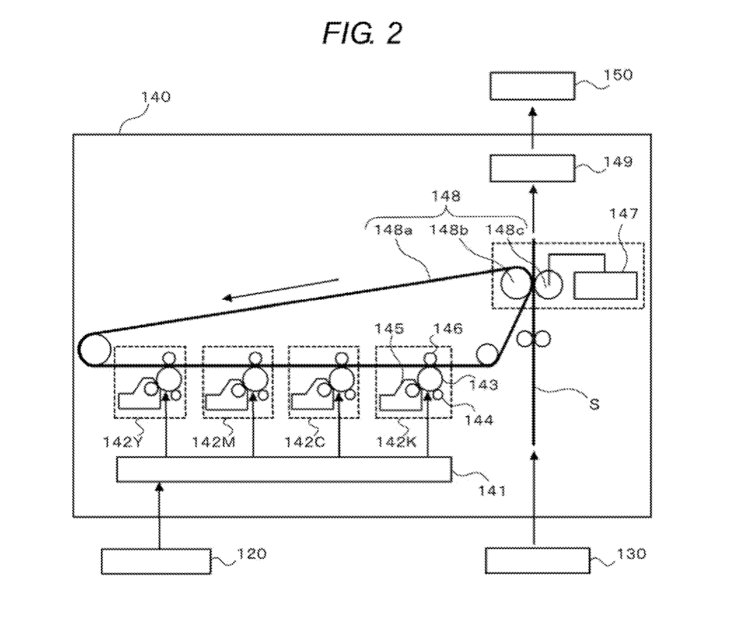

The printing unit 140 includes a quadri-linked tandem type printing unit which reproduces colors on a sheet by combining toner of four colors of yellow (Y), magenta (M), cyan (C), and black (K). As illustrated in FIG. 2, the printing unit 140 includes an exposure unit 141, image forming stations 142Y to 142K, a power supply unit 147, the transfer unit 143, and a fixing unit 149.

The exposure unit 141 is a latent image forming unit which forms an electrostatic latent image on a photoconductive drum 143. The exposure unit 141 functions as a toner image forming unit along with the image forming stations 142Y to 142K which will be described later. The exposure unit 141 includes, for example, a laser irradiation unit which radiates laser light at the photoconductive drum 143 in a pattern of the color to be printed or transferred to the printed sheet. The exposure unit 141 selectively radiates a laser light source or light of a light emitting diode (LED) toward the surface of the photoconductive drum 143 based on image data which is processed in the image processing unit 120. In this manner, the exposure unit 141 forms an electrostatic latent image on the surface of the photoconductive dram 143.

The image forming stations 142Y to 142K are primary transfer units which transfer toner images of yellow (Y), magenta (M), cyan (C), and black (K) to an intermediate transfer belt 148a, respectively. The image forming stations 142Y to 142K function as toner image forming units along with the exposure unit 141. The image forming stations 142Y to 142K respectively include the photoconductive drum 143, a charger for charging 144 the drum 143, a developing unit 145, and a primary transfer roller 146.

The photoconductive drum 143 is a cylindrical or drum shaped image carrier in which a toner image is developed on a peripheral surface thereof. The photoconductive drum 143 includes, for example, an organic photoconductive drum which includes an organic photoconductor (OPC) on the peripheral surface thereof. The peripheral surface of the photoconductive drum 143 comes into contact with the intermediate transfer belt 148a. The photoconductive drum 143 rotates according to a transport speed of the intermediate transfer belt 148a.

The charger 144 is a charger which charges the photoconductive drum 143. The charger 144 is arranged on the peripheral surface of the photoconductive drum 143. The charger 144 uniformly charges the surface of the photoconductive drum 143 by creating a discharge toward the peripheral surface of the photoconductive drum 143.

The developing unit 145 is a developing unit which develops a toner image on the surface of the photoconductive drum 143. In addition, the toner which is supplied by the developing unit 145 may be decolorable toner which may be decolored in response to a specific stimulus such as light, heat, a pressure, or friction, or may be a non-decolorable toner which does not decolor.

The primary transfer roller 146 is a bias roller which transfers the toner image on the peripheral surface of the photoconductive drum 143 to the intermediate transfer belt 148a. The primary transfer roller 146 includes, for example, a conductive roller. The primary transfer roller 146 is arranged at a position at which the roller faces the photoconductive drum 143 with the intermediate transfer belt 148a interposed therebetween. A voltage with a polarity which is reverse to a charged polarity of the toner image is applied to the primary transfer roller 146 by a power supply unit which is not shown. Due to the voltage with the reverse polarity, the toner image on the peripheral surface of the photoconductive drum 143 is transferred to the intermediate transfer belt 148a in an electrostatic manner. When the toner image is transferred to the intermediate transfer belt 148a, the surface of the photoconductive drum 143 is cleaned by a cleaning unit which is not shown.

The power supply unit 147 is a power supply unit which applies a voltage to the secondary transfer roller 148c. The power supply unit 147 includes, for example, a high-voltage step-up transformer of which a maximum output voltage is 10 KV. The power supply unit 147 is configured so that an output voltage thereof may be changed according to a control of the control unit 170. The power supply unit 147 increases an input voltage to a voltage which is designated by the control unit 170, and outputs the voltage to the secondary transfer roller 148c. In addition, for easy understanding, a voltage which is applied to the secondary transfer roller 148c will be referred to as “transfer bias voltage” in the following descriptions.

The transfer unit 148 is a secondary transfer unit which transfers the toner image which is formed on the surface of the intermediate transfer belt 148a to the sheet S. The transfer unit 148 includes the intermediate transfer belt 148a, an opposing roller 148b, and the secondary transfer roller 148c.

The intermediate transfer belt 148a is an intermediate transfer medium on which a toner image of each color is formed by the image forming stations 142Y to 142K. The intermediate transfer belt 148a is formed of a loop shaped endless belt. The intermediate transfer belt 148a is arranged so as to pass through the secondary transfer roller 148c and the opposing roller 148b therebetween. The intermediate transfer belt 148a makes a pressure contact with the sheet S between the secondary transfer roller 148c and the opposing roller 148b when the sheet S is fed from the sheet feeding unit 130.

The opposing roller 148b is a transport roller which supports the intermediate transfer belt 148a, and transports the intermediate transfer belt 148a counterclockwise in drawings. The opposing roller 148b is arranged at a position at which the roller faces the secondary transfer roller 148c with the intermediate transfer belt 148a interposed therebetween.

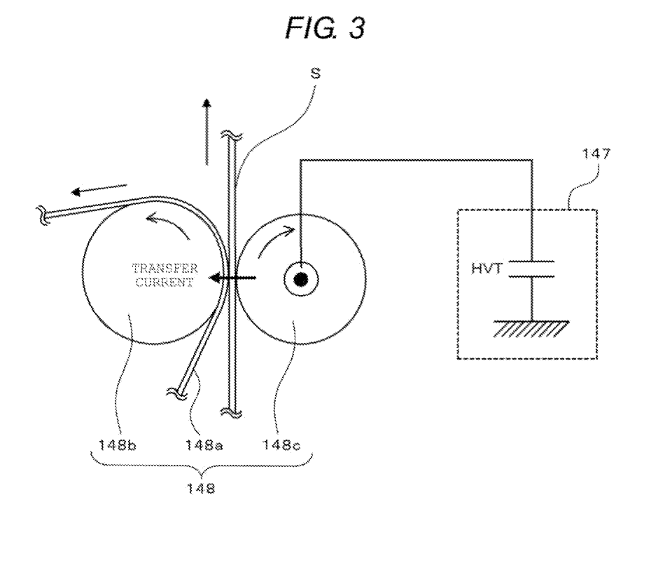

The secondary transfer roller 148c is a bias roller which transfers the toner image on the surface of the intermediate transfer belt 148a to the sheet S. The secondary transfer roller 148c includes, for example, a conductive roller. The secondary transfer roller 148c is arranged at a position at which the roller faces the photoconductive drum 143 with the intermediate transfer belt 148a interposed therebetween. A transfer bias voltage, the polarity of which is reverse to the charged polarity of the toner image is applied to the secondary transfer roller 148c by the power supply unit 147. When the transfer bias voltage is applied to the secondary transfer roller 148c, for example, as illustrated in FIG. 3, a minute current (hereinafter, referred to as “transfer current”) flows on the sheet S, and the toner image is transferred onto the sheet S. In addition, the opposing roller 148b is arranged inside the loop of the intermediate transfer belt 148a (that is, toner image non-forming surface side of intermediate transfer belt 148a) in FIGS. 2 and 3, however, the secondary transfer roller 148c may be arranged inside the loop of the intermediate transfer belt 148a. In this case, a transfer bias voltage with the same polarity as the charged polarity of the toner image is applied to the secondary transfer roller 148c so that a repulsive force works in the toner.

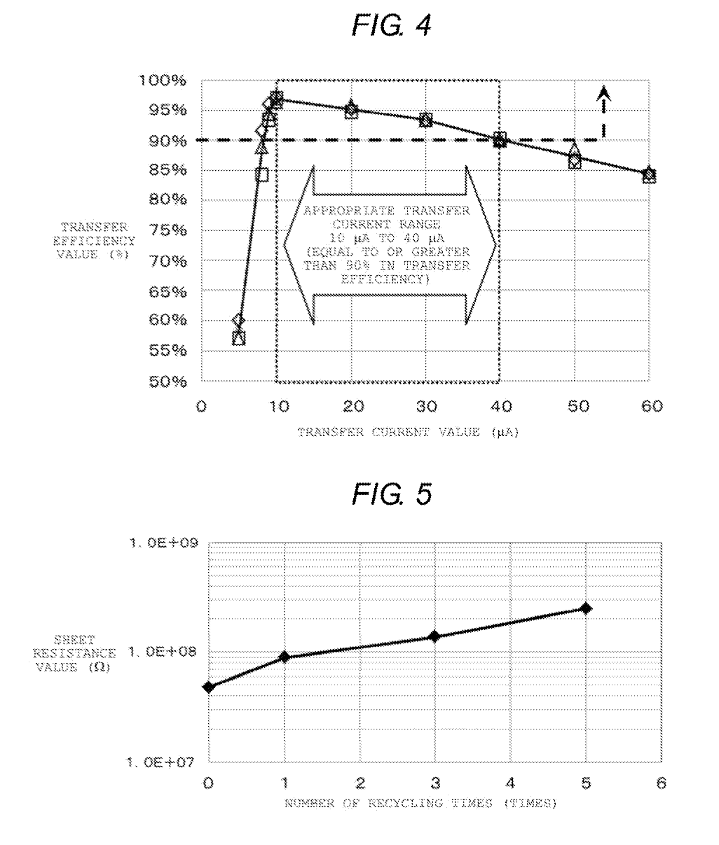

In addition, a range of a transfer current in which a good image is acquired (hereinafter, referred to as “appropriate transfer current range”) is set to a value which is fixed to some extent, without taking into consideration a state or condition of the sheet S. FIG. 4 is a diagram illustrating a relationship between a transfer current and transfer efficiency when the sheet S passes through the transfer unit 148 at a speed of 150 mm/s. When transfer efficiency for obtaining a good image is desired to be 90% or more, the appropriate transfer current range is set to 10 μA to 40 μA. When a transfer current is lower than a lower limit of the appropriate transfer current range (10 μA in example in FIG. 4), density of an image transferred to the sheet S becomes low, and when the transfer current is higher than an upper limit of the appropriate transfer current range (40 μA in example in FIG. 4), the image which is transferred to the sheet S deteriorates due to an excessive transfer of toner thereto.

However, a sheet resistance of the sheet S, which is a factor causing variation in the transfer current, changes greatly with respect to the number of times the sheet S has been printed on with decolorable toner and then erased and reused, as illustrated in FIG. 5. There is no problem if it is possible to control the power supply unit 147 with a constant current so that the transfer current falls within the appropriate transfer current range, however, in order to maintain the constant current, it is necessary to perform a feedback control with respect to the power supply unit 147 by measuring the current value which flows on the sheet S to the control unit 170, or the like and adjusting the power supply 147 output accordingly. However, as the printing speed of a current printing apparatus is increased, the sheet S passes through the transfer unit 148 at an extremely high speed. For this reason, it is practically not easy to measure a current value of the sheet S in the short time period of the sheet S passing through the transfer unit 148, feed the measured current value back, and control the power supply unit 147 with the constant current based on the fed back current value. In other words, it is hard to maintain a constant transfer current on the entire sheet S in a case of an image forming apparatus which has a function of performing printing on a recycled sheet.

In addition, FIG. 5 is data which is measured under an environment of a relative humidity of 50%. In addition, in FIG. 5, a sheet of which the number of recycled times is once is a sheet on which solid printing on both sides, and decoloring processing on both sides thereof, is performed once, respectively. The solid printing is printing in which the surface of the sheet S is subject to 100% printing without spaces. As understood from FIG. 5, the sheet resistance of an unused, i.e., a fresh, sheet which has not recycled even once (hereinafter, referred to as “new sheet”) is 4.8×10⁷ Ω (48 MΩ), however, in contrast to this, a sheet resistance of a sheet which has been recycled five times increases up to 2.5×10⁸ Ω (250 MΩ).

In addition, in the following descriptions, a sheet which is recycled up to the number of times which is predetermined by a manufacturer of the apparatus will be referred to as a “sheet of which recycling is limited”. As an example, according to the embodiment, the “sheet of which recycling is limited” is set to a sheet of which the number of recycled times is five times. The reason for this is that the thickness of the sheet of which the number of recycled times is five times increases up to a level of a plastic sheet, and the sheet is no longer adequate as an image forming medium because the characteristic of the sheet has changed due to much toner being attached on its surface.

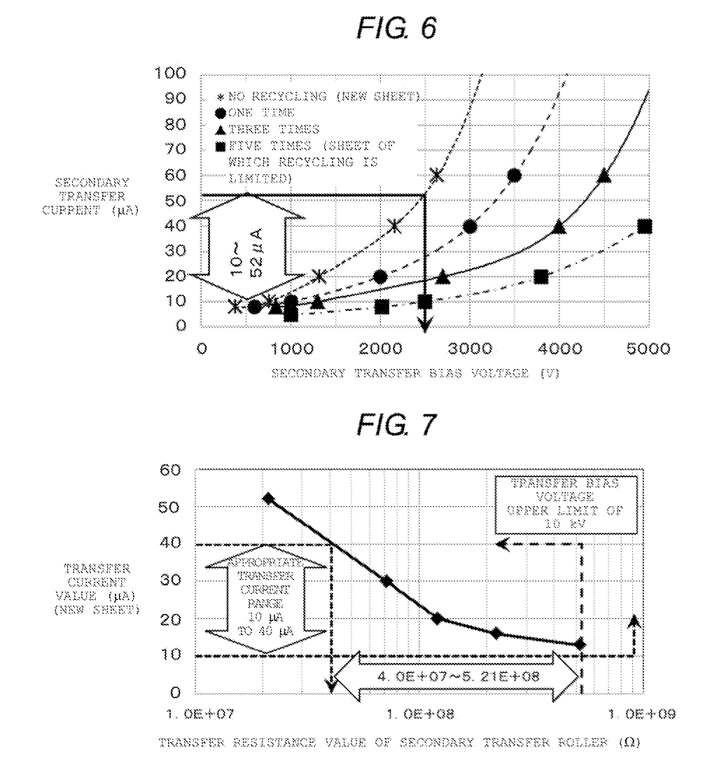

FIG. 6 is a diagram illustrating a relationship between the number of times the sheet S has been recycled and a transfer bias voltage when a relative humidity is 50%. In general, since the transfer bias voltage is determined based on a new sheet, the voltage has a value of approximately 1,500 V. However, a transfer bias voltage (hereinafter, referred to as “lower limit transfer bias voltage”) which may cause a transfer current of a lower limit in the appropriate transfer current range (10 μA in the embodiment) to flow on the sheet of which recycling is limited is 2,500 V as understood from FIG. 6. When the transfer bias voltage is set to 1,500 V, which is commonly used, only a transfer current which is smaller than 10 μA flows on the sheet of which recycling is limited. In this case, it is not possible for the image forming apparatus 100 to perform appropriate printing on the sheet S.

Thus, in order to perform printing appropriately on all sheets S (that is, including a new sheet and a sheet of which recycling is limited), it is necessary to set the transfer bias voltage to be equal to or greater than 2,500 V. However, when the transfer bias voltage is set to equal to or greater than 2,500 V, as understood from FIG. 6, a transfer current which flows on the new sheet becomes 52 μA. The value greatly exceeds an upper limit of the appropriate transfer current range (40 μA in the embodiment), and also in this case, it is not possible for the image forming apparatus 100 to perform appropriate printing on the new sheet S.

Therefore, according to the embodiment, it is possible to perform setting such that a transfer current does not exceed the upper limit of the appropriate transfer current range, even in a case of a new sheet, by adjusting in advance of printing of sheets S a resistance value of a resistance component (hereinafter, referred to as “transfer resistance value”) which is present on a path on which the transfer current flows, in a manufacturing stage of the apparatus.

FIG. 7 is a diagram illustrating a relationship between a transfer resistance value and a transfer current value when applying the lower limit transfer bias voltage (2,500 V in the embodiment) to the secondary transfer roller 148c under an environment of a temperature of 23° C., and a relative humidity of 50%. According to the embodiment, importance of the transfer resistance value of the secondary transfer roller 148c in the transfer resistance value of the entire transfer unit 148 is extremely high, i.e., it predominates. For this reason, the transfer resistance value of the secondary transfer roller 148c is regarded as the transfer resistance value of the entire transfer unit 148. As understood from FIG. 7, according to the embodiment, the lower limit transfer resistance value is 4.0×10⁷ Ω (40 MΩ). In addition, the “lower limit transfer resistance value” is a transfer resistance value of the transfer unit 143 in which a transfer current which flows on the sheet S becomes the upper limit of the appropriate transfer current range, when the sheet S is a new sheet, and the transfer bias voltage is the lower limit transfer bias voltage.

In addition, according to the embodiment, a maximum output voltage of the power supply unit 147 is 10 KV. A transformer which may output a voltage exceeding 10 KV is large and expensive, and it is not practical to mount the transformer onto relatively small electrical equipment which is provided in a home or an office. For this reason, the transfer bias voltage should be equal to or smaller than 10 KV, however, in this case, when the transfer resistance value becomes too large, it is not possible that the power supply unit 147 outputs a voltage which satisfies a lower limit of the appropriate transfer current range. When the sheet S is the sheet of which recycling is limited, and of which a sheet resistance is maximum, if a transfer resistance value is larger than 5.21×10⁸ Ω (521 MΩ), a transfer current becomes smaller than the lower limit of the appropriate transfer current range (10 μA in the embodiment), even when the transfer bias voltage is set to the maximum output voltage of the power supply unit 147.

Therefore, according to the embodiment, by setting the transfer resistance value of the secondary transfer roller 148c to a value in a range of 4.0×10⁷ Ω to 5.21×10⁸ Ω, it is possible to cause the transfer current to fall within the appropriate transfer current range whatever the sheet S is (that is, whether sheet S is a new sheet or a sheet of which recycling is limited). In addition, in the following descriptions, when the sheet S is a sheet of which recycling is limited, acid the transfer bias voltage is the maximum Output voltage of the power supply unit 147, a transfer resistance value for which a transfer current which flows on the sheet S is the lower limit of the appropriate transfer current range is referred to as an “upper limit transfer resistance value”. According to the embodiment, the upper limit transfer resistance value is 5.21×10⁸ Ω (521 MΩ).

An adjusting method of the transfer resistance value is arbitrary, however, for example, when the secondary transfer roller 148c includes conductive rubber, the transfer resistance value of the secondary transfer roller 148c may be adjusted by adjusting an amount of a conductive material which is included in the conductive rubber in a manufacturing stage of the secondary transfer roller 148c. In addition, when the conductive rubber or other material of the secondary transfer roller 148c is formed of a mixture of a plurality of rubber or other materials of which a resistance value is different, the transfer resistance value of the secondary transfer roller 148c may be adjusted by adjusting a mixing ratio of the rubber or other material.

Returning to FIG. 1, the fixing unit 149 is a pressurizing heating unit which fixes a toner image onto the sheet S. The fixing unit 149 fixes a toner image onto the sheet S by heating the sheet S while pressing the sheet S on which the toner image is being formed between the transfer belt 148a and the secondary transfer roller 148c.

The sheet discharging unit 150 is a discharging unit which discharges the sheet S to the outside of the image forming apparatus 100. The sheet discharging unit 150 discharges the sheet S, on which the toner image is fixed by use of the fixing unit 149, to the outside of the image forming apparatus 100 from a discharging port which is not shown.

Referring back to FIG. 1, the sensor unit 160 is a sensor which measures an operational environment of the printing unit 140, such as a temperature or humidity. The sensor unit 160 includes, for example, a temperature sensor, or a humidity sensor. When measuring the temperature or humidity of the surroundings or the inside of the printing unit 140, the sensor unit 160 transmits a measurement result thereof to the control unit 170.

The control unit 170 includes a processing unit such as a processor. The control unit 170 executes various operations including “transfer processing” which will be described later by being operated according to a program which is stored in a Read Only Memory (ROM) or a Random Access Memory (RAM) which is not shown.

The storage unit 180 includes a storage unit which may read and write data such as a Dynamic Random Access Memory (DRAM), a Static Random Access Memory (SRAM), a semiconductor memory, or a hard disk. Various information such as voltage correction information 181 and voltage correction information 182 are stored in the storage unit 180.

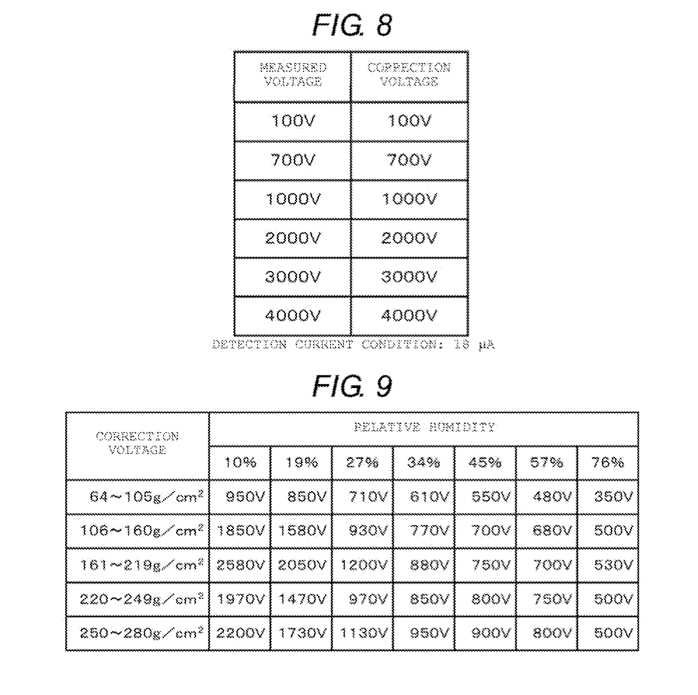

The voltage correction information 181 is information for correcting a transfer bias voltage which is applied to the secondary transfer roller 148c. Specifically, the voltage correction information 181 is information which corresponds to a fluctuation of a transfer resistance value of the secondary transfer roller 148c due to changes in operational environment. As illustrated in FIG. 8, for example, the voltage correction information 181 includes information in which a measured voltage which is measured in the secondary transfer roller 148c, and a correction voltage which is used at a time of the measured voltage are correlated with each other. In addition, the measured voltage is a voltage which is measured in the secondary transfer roller 148c when a current of a preset current value (for example, 18 μA) is caused to flow in the secondary transfer roller 148c when there is no sheet S between the secondary transfer roller 148c and the opposing roller 148c. In FIG. 8, the measured voltage and the correction voltage have the same value, however, the value may be different.

The voltage correction information 182 is information for correcting the transfer bias voltage which is applied to the secondary transfer roller 148c. Specifically, the voltage correction information 182 is information which corresponds to a fluctuation in the sheet resistance of the sheet S due to a change in operational environment. As illustrated in FIG. 9, for example, the voltage correction information 182 includes information in which humidity which is measured in the sensor unit 160 and a type of the sheet S (for example, weight per unit area of sheet S), and a correction voltage which is used at a time of the humidity measurement and evaluation of the type of the sheet are correlated with each other. In addition, the type of the sheet S is information which is set by a user using a user interface which is not shown.

Sheet type information 183 is information which denotes a type of the sheet S with which printing is performed with the image forming apparatus 100. Specifically, the information is information which denotes weight per unit area of the sheet S. A user inputs the type of the sheet S in the image forming apparatus 100 using the user interface which is not shown, i.e., new or used and erased. In addition, the sheet type information 183 may be information such as “thick paper 1” or “thick paper 2” to be easy to understand for a user.

Subsequently, operations of the image forming apparatus 100 having the above-described configuration will be described.

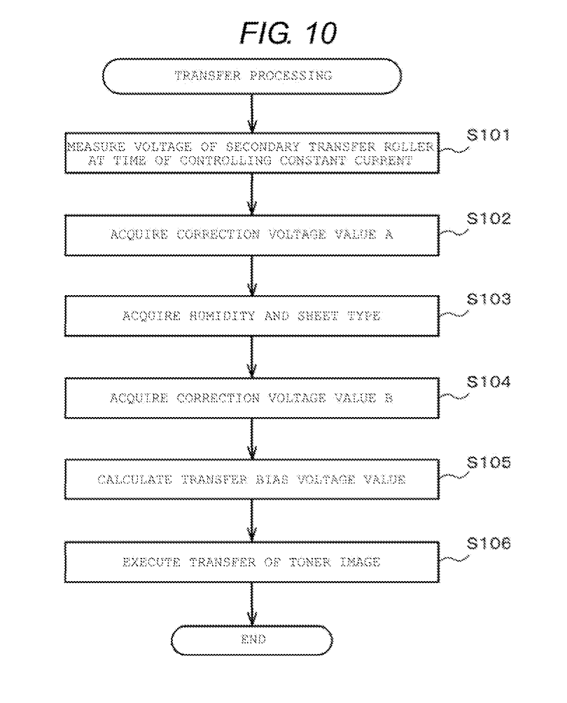

The control unit 170 of the image forming apparatus 100 starts transfer processing when receiving a printing start command from the user interface, not shown. Hereinafter, the transfer processing will be described with reference to a flowchart in FIG. 10.

A transfer resistance value of the conductive roller which is used in the secondary transfer roller 148c is changed due to a change in a temperature or humidity. FIG. 11 has results for the transfer resistance values of the plurality of conductive rollers (samples 1 to 5) with different configurations which are measured while changing the temperature or humidity. As understood from FIG. 11, due to the change in the temperature or humidity, the transfer resistance value fluctuates greatly. The transfer resistance value has a large influence on the value of the transfer current which flows on or through the sheet S. For this reason, it is necessary for the control unit 170 to change the transfer bias voltage which is applied to the secondary transfer roller 148c so that the transfer current value becomes a specified value according to a change in environment.

Then, the control unit 170 causes a constant current (for example, current of 18 μA) to flow in the secondary transfer roller 148c before entering the sheet S between the secondary transfer roller 148c and the opposing roller 148b (belt 148a) to correspond to the fluctuation in the transfer resistance value, and measures a voltage value of the secondary transfer roller 148c at this time. At this time, the control unit 170 causes the constant current to flow in the secondary transfer roller 148c by controlling the power supply unit 147 with the constant current (STEP S101).

The control unit 170 acquires a correction voltage value (hereinafter, referred to as “correction voltage value A”) which corresponds to the fluctuation in the transfer resistance value from the voltage correction information 181. Specifically, the control unit 170 collates a voltage which is measured in STEP S101 with the voltage correction information 181 which is stored in the storage unit 180. In addition, the control unit 170 acquires a voltage value which is correlated with the measured voltage as the correction voltage value A (STEP S102).

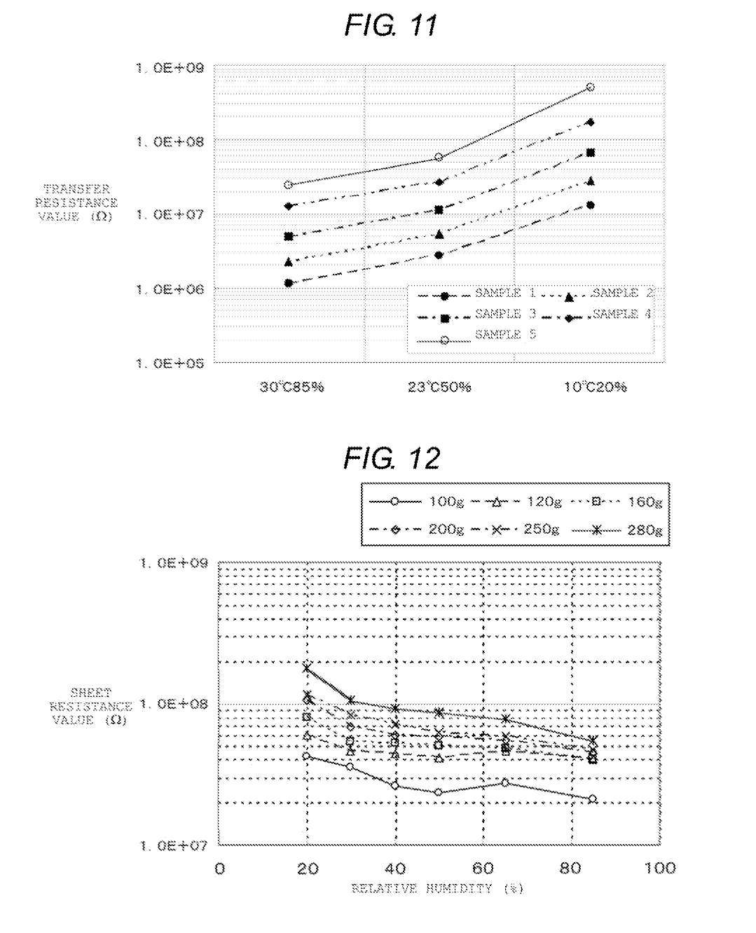

In addition, the secondary transfer roller 148c is not the only unit of which the resistance value fluctuates due to an environment. Also in the sheet S, a sheet resistance value changes due to an environment. FIG. 12 illustrates results of sheet resistance measurement values of a plurality of sheets (sheets of 100 g/cm² to 280 g/cm²) of which weights per unit area are different which are measured while changing humidity. As understood from FIG. 12, the sheet resistance value fluctuates greatly due to a change in the humidity. Since the fluctuation in the sheet resistance value has a large influence on a value of the transfer current which flows in the sheet S, it is necessary for the control unit 170 to change the transfer bias voltage according to the change in the humidity.

Therefore, in order to have correspondence with the fluctuation in the sheet resistance value, the control unit 170 acquires a measurement value of a relative humidity of the surroundings, or the inside, of the printing unit 140 from the sensor unit 160. At this time, the control unit 170 also acquires the type of the sheet S which is stored in the sheet type information 183 of the storage unit 180 (STEP S103).

The control unit 170 acquires a correction voltage value (hereinafter, referred to as “correction voltage value B”) which corresponds to the fluctuation in the sheet resistance value from the voltage correction information 182. Specifically, the control unit 170 collates the type of the sheet which is acquired in STEP S103 and the measurement value of a relative humidity with the voltage correction information 182 which is stored in the storage unit 180. In addition, the control unit 170 acquires a voltage value which is correlated with the type of the sheet and the measurement value as the correction voltage value B (STEP S104).

The control unit 170 acquires a value in which the correction voltage value A which is acquired in STEP S102 and the correction voltage value B which is acquired in STEP S104 are added up as a voltage value of the transfer bias voltage applied to the secondary transfer roller 148c (STEP S105).

The control unit 170 applies the transfer bias voltage of the voltage value acquired in STEP S105 to the secondary transfer roller 148c while rotating the secondary transfer roller 148c and the opposing roller 148b at a constant speed. In this manner, the control unit 170 transfers the toner image on the intermediate transfer belt 148a to the sheet S (STEP S 106). When the image transfer ends, the control unit 170 ends the transfer processing.

According to the embodiment, since the transfer resistance value of the transfer unit 148 is set to a value which is larger than the lower limit transfer resistance value, the transfer current does not exceed the upper limit of the appropriate transfer current range even when the sheet S is a new sheet of which a sheet resistance value is low, for example. For this reason, in the image forming apparatus 100 according to the embodiment, there is little possibility of occurrence of defective transfer due to excessive transfer current.

In addition, since the image forming apparatus 100 according to the embodiment sets the transfer resistance value of the transfer unit 148 as smaller than the upper limit transfer resistance value, the transfer current is not lower than the lower limit of the appropriate transfer current range even when the sheet S is a new sheet of which a sheet resistance value is high, for example. For this reason, in the image forming apparatus 100 according to the embodiment, there is little possibility of occurrence of defective image transfer due to lack of transfer current.

In addition, the above-described embodiment is an example, and various modifications and applications may be made.

For example, in the above-described embodiment, the image acguiring unit 110 is described as a scanner, however, the image acquiring unit 110 is not limited to the scanner. The image acguiring unit 110 may be a communication interface which acguires image information from an external device, for example, an external interface such as a Local Area Network (LAN) interface and a Universal Serial Bus (USB) interface.

In addition, in the above-described embodiment, the transfer resistance value of the transfer unit 148 is adjusted by adjusting the transfer resistance value of the secondary transfer roller 148c, however, the method of adjusting the transfer resistance value of the transfer unit 148 is not limited to adjusting of the transfer resistance value of the secondary transfer roller 148c. The adjusting of the transfer resistance value of the transfer unit 148 may be performed when a manufacturer of the apparatus, or the like, adjusts or selects a portion of the transfer unit 148 other than the secondary transfer roller 148c, for example, the transfer resistance value of the intermediate transfer belt 148a or the opposing roller 148b, for example.

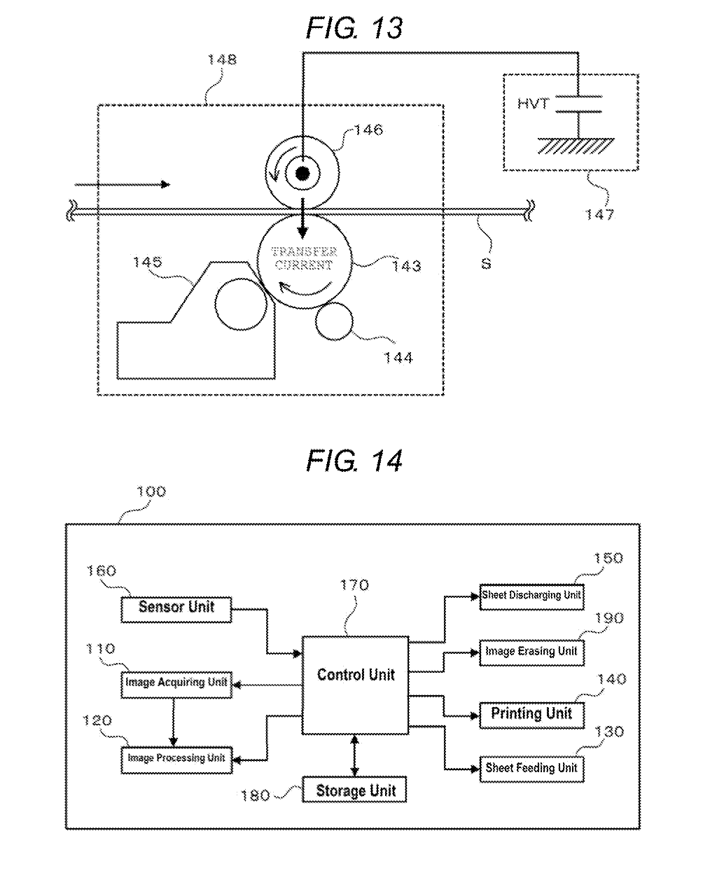

In addition, according to the above-described embodiment, the printing unit 140 is a printing apparatus of an intermediate transfer type, however, the printing unit 140 may be a printing apparatus of a direct transfer type as illustrated in FIG. 13. In an example in FIG. 13, the photoconductive drum 143, the charger 144, the developing unit 145, and the primary transfer roller 146 may be considered as the transfer unit 148. In addition, also in this case, the transfer resistance value of the transfer unit 148 is set to a value in a range between the lower limit transfer resistance value and the upper limit transfer resistance value. In addition, in this case, the power supply unit 147 may output a voltage which is equal to or greater than the lower limit transfer bias voltage to the primary transfer roller 146.

In addition, according to the above-described embodiment, the image forming apparatus 100 is described as an apparatus without a decoloring function, however, the image forming apparatus 100 may have the decoloring function. For example, as illustrated in FIG. 14, the image forming apparatus 100 may include a decoloring unit 190 which decolors an image of decoloring toner which is formed on the sheet S by applying a specific external stimulus such as light, heat, a pressure, or friction to the sheet S. The decoloring unit 190 may adopt various configurations which are known.

In addition, according to the above-described embodiment, the printing unit 140 is described as a color printing apparatus which has toner of four colors of yellow (Y), magenta (M), cyan (C), and black (B), however, the printing unit 140 may be a monochrome printing apparatus which has toner of only one color. In addition, the printing unit 140 does not necessarily have toner of four colors. For example, colors of the toner that the printing unit 140 may have may be three colors or less, or five colors or more.

In addition, according to the above-described embodiment, the printing unit 140 is described as a tandem type printing unit, however, the printing unit 140 may be a rotary type printing unit.

In addition, according to the above-described embodiment, a speed of the sheet S which passes through the transfer unit 148 (speed of sheet S passing through bias roller, and referred to as “transport speed” hereinafter) is described to be 150 mm/s, however, the transport speed of the sheet S is not limited to 150 mm/s. The transport speed of the sheet S may be lower than 150 mm/s, or may be higher than 150 mm/s. In this case, the appropriate transfer current range changes in proportion to the transport speed of the sheet S. That is, the higher the transport speed of the sheet S is, the larger the necessary transfer current is.

In addition, according to the above-described embodiment, the image forming apparatus 100 is described as electrical equipment for home or office (for example, copy machine, printer, fax machine) which is provided at a home or an office, however, the image forming apparatus 100 is not limited to this electrical equipment. For example, the image forming apparatus 100 may be a printing apparatus for business which performs mass printing of a newspaper, a magazine, or advertisements.

The image forming apparatus 100 according to the embodiment may be executed using an exclusive system, or may be executed using a normal computer system. For example, the image forming apparatus 100 may be constituted by storing a program for executing the above-described operations in a recording medium which may be read from a computer such as an optical disc, a semiconductor memory, a magnetic tape, or a flexible disk, and distributing thereof, by installing the program in a computer, and by executing the above-described processing. In addition, the above-described program may be downloaded to a computer by storing the program in a disk unit which is included in a server device on a network such as the Internet. In addition, the above-described functions may be executed in collaboration with an operating system (OS) and application software. In this case, portions except for the operating system may be stored in a medium, and may be distributed, or the portions except for the operating system may be stored in the server device, and may be downloaded to a computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a power supply unit that outputs a transfer bias voltage; and
a transfer unit that electrostatically transfers a toner image onto a sheet using a transfer bias voltage applied by the power supply unit, and has a transfer resistance value equal to or greater than 4.0×10⁷ Ω.

2. The apparatus according to claim 1,
wherein the transfer resistance value of the transfer unit is in a range of 4.0×10⁷ Ω to 5.21×10⁸ Ω.

3. The apparatus according to claim 1, further comprising:
a toner image forming unit that forms the toner image using decolorable toner,
wherein the transfer unit transfers the toner image formed using the decolorable toner onto the sheet.

4. The apparatus according to claim 1, further comprising:
a decoloring unit that decolors an image on the sheet formed using decolorable toner.

5. The apparatus according to claim 1,
wherein the transfer unit includes a bias roller that transfers a toner image onto a sheet by charging the image using a transfer bias voltage applied by the power supply unit, an opposing roller that faces the bias roller with the sheet interposed therebetween, and an intermediate transfer medium that comes into contact with the sheet between the bias roller and the opposing roller,
wherein a transfer resistance value of at least one of the bias roller, the opposing roller, and the intermediate transfer medium is adjusted so that the transfer resistance value of the transfer unit is equal to or greater than 4.0×10⁷ Ω.

6. The apparatus according to claim 5,
wherein a transfer resistance value of at least one of the bias roller, the opposing roller, and the intermediate transfer medium is adjusted so that the transfer resistance value of the transfer unit is in a range of 4.0×10⁷ Ω to 5.21×10⁸ Ω.

7. The apparatus according to claim 1,
wherein the transfer unit includes a bias roller that transfers a toner image onto a sheet by charging the image using a transfer bias voltage applied by the power supply unit, and a photoconductive drum that comes into contact with one face of the sheet and faces the bias roller with the sheet interposed therebetween, and
wherein a transfer resistance value of at least one of the bias roller and the photoconductive drum is adjusted so that the transfer resistance value of the transfer unit is equal to or greater than 4.0×10⁷ Ω.

8. The apparatus according to claim 7,
wherein a transfer resistance value of at least one of the bias roller and the photoconductive drum is adjusted so that the transfer resistance value of the transfer unit is in a range of 4.0×10⁷ Ωto 5.21×10⁸ Ω.

9. The apparatus according to claim 1, further comprising:
a bias roller including a conductive roller which transfers a toner image onto a sheet by charging the image using a transfer bias voltage applied by the power supply unit,
wherein a resistance value of a conductive rubber constituting the conductive roller is adjusted so that the transfer resistance value of the transfer unit is equal to or greater than 4.0×10⁷ Ω.

10. The apparatus according to claim 9,
wherein a resistance value of a conductive rubber constituting the conductive roller is adjusted so that the transfer resistance value of the transfer unit is in a range of 4.0×10⁷ Ωto 5.21×10⁸ Ω.

11. A method of printing an image on sheets having different numbers of instances of recycling thereof by decoloring a decolorable toner previously printed thereon, comprising:
measuring a resistance of the recycled sheets and determining a resistance thereof correlated with the number of instances of recycling thereof;
determining, based upon the characteristics of the image printing device, a transfer current range of an image transfer device configured to transfer a latent image to a sheet over which an image can be printed with acceptable features; and
configuring the resistance of the image transfer device to provide the transfer current range based upon the resistance of the image transfer device.

12. The method of claim 11, wherein the image transfer device includes at least an image transfer belt, a first roller about which the belt is passed, and a second roller engageable with a surface of the belt to press the belt between the first and second rollers.

13. The method of claim 12, wherein the resistance of the first roller is configured to provide the transfer current range.

14. The method of claim 12, wherein the first roller comprises conductive rubber.

15. The method of claim 12, further including configuring the resistance of at least one of the first roller, the second roller and the image transfer belt to provide the transfer current range based upon the resistance of the image transfer device.

16. The method of claim 15, further including configuring the resistance of the image transfer device to yield a transfer current of between 10 and 40 microamperes.

17. The method of claim 11, wherein a power supply for establishing the transfer current through the image forming device supplies at most 10 kV.

18. The method of claim 11, wherein the transfer current is controlled to be in a range of 4.0×10⁷ Ω to 5.21×10⁸ Ω.

19. A image forming device for forming an image on new and recycled sheets using toner by passing a latent image on a transfer device having a resistance to a sheet using a transfer current, comprising:
a power supply unit that outputs a transfer bias voltage; and
at least one image transfer component having an electrical resistance value selected to enable the formation of a transfer current between a sheet and the image transfer component selected to ensure a desired image quality of an image printed on both new and recycled sheets.

20. The image forming device of claim 19, wherein the resistance value of the image transfer component is 4.0×10⁷ Ω to 5.21×10⁸ Ω.
